(19) United States
(12) Patent Application Publication
(10) Pub. No.: US 2014/0085642 A1
(43) Pub. Date: Mar. 27, 2014

(54) LIGHTING APPARATUS FOR MEASURING THE POSITION OF A MOBILE TERMINAL, AND POSITION MEASURING SYSTEM USING SAME

(71) Applicants: Sun-Woo Kim, Gyeonggi-do (KR); Sung-min Koh, Daegu-si (KR); Seung-Eon Kim, Gyeonggi-do (KR); Jin-Su Kim, Gyeonggi-do (KR); Chun-Su Ahn, Seoul (KR)

(72) Inventors: Sun-Woo Kim, Gyeonggi-do (KR); Sung-min Koh, Daegu-si (KR); Seung-Eon Kim, Gyeonggi-do (KR); Jin-Su Kim, Gyeonggi-do (KR); Chun-Su Ahn, Seoul (KR)

(73) Assignee: INDUSTRY-UNIVERSITY COOPERATION FOUNDATION HANYANG UNIVERSITY, Seoul (KR)

(21) Appl. No.: 14/117,677

(22) PCT Filed: May 17, 2012
(86) PCT No.: PCT/KR2012/003895

§ 371 Date: Nov. 14, 2013

(30) Foreign Application Priority Data
May 17, 2011 (KR) 10-2011-0046378
May 17, 2011 (KR) 10-2011-0046394

(51) Int. Cl. F21K 99/00; G01B 11/14

(52) U.S. Cl. CPC F21K 9/50; G01B 11/14
USPC 356/614; 362/235

(57) ABSTRACT

A lighting apparatus for measuring the position of a mobile terminal is disclosed. The disclosed lighting apparatus may be a lighting apparatus for measuring the position of a mobile terminal by way of visible light communication. The lighting apparatus comprises one or more boundary lighting devices positioned in a boundary part of the lighting apparatus, which are configured to emit visible light that includes information for identifying a position of the mobile terminal (identification information); one or more inner lighting devices positioned in an inner part of the lighting apparatus, which are configured to emit visible light that includes the identification information; and one or more boundary concentrator units, which are implemented respectively on at least some of the one or more boundary lighting devices, and which are configured to concentrate the visible light emitted from the at least some boundary lighting devices.

### CROSS-REFERENCE TO RELATED APPLICATIONS

This application is a National Phase Application of PCT International Application No. PCT/KR2012/003895, which was filed on May 17, 2012, and which claims priority from Korean Patent Application No. 10-2011-0046378, filed with the Korean Intellectual Property Office on May 17, 2011, and Korean Patent Application No. 10-2011-0046394, filed with the Korean Intellectual Property Office on May 17, 2011. The disclosures of the above patent applications are incorporated herein by reference in their entirety.

### BACKGROUND

1. Technical Field

Embodiments of the present invention relate to a lighting apparatus, more particularly to a lighting apparatus that utilizes visible light communication to measure the position of a mobile terminal.

2. Description of the Related Art

With growing trends towards convenient lifestyles, there is an increasing amount of interest in position measuring technology with which users can ascertain their positions in real time.

Since users generally carry at least one or more mobile terminals, the position measurement of a user can be performed by using a mobile terminal.

Methods of measuring the position measurement of a mobile terminal can be divided into positioning using GPS (Global Positioning System), positioning using a localization service provided by a mobile network operator, and positioning using RFID (Radio Frequency IDentification), infrared rays or ultrasonic waves.

A positioning technique using GPS may involve receiving GPS signals through a mobile terminal equipped with an antenna capable of obtaining GPS signals, computing the current position of the user based on the received GPS signals, and showing the current position on the screen of the mobile terminal.

Positioning using a localization service provided by a mobile network operator may involve determining which base station the user (i.e. a subscriber of the localization service provided by the mobile network operator) is connected to, and then providing the user with the information that the user is located within a service area of a corresponding base station.

A positioning technique using RFID, infrared rays, or ultrasonic waves may involve measuring the current position of the user by using wireless signals, infrared rays, or ultrasonic waves emitted from three or more access points (AP).

However, with positioning techniques using GPS, the position measurement may not be possible in areas that cannot be reached by GPS signals (for example, indoor areas or areas of dense building concentration). Also, with positioning techniques using a localization service provided by a mobile network operator, it may be difficult to estimate the position of the user to within several meters, because of the vast area (several hundreds of meters to several kilometers) covered by a base station. Furthermore, positioning techniques using RFID may not be economically viable, since they would require the installation of numerous RFID readers, while positioning techniques using infrared rays or ultrasonic waves may not be suitable for position measurement in a typical indoor office environment, as these cannot be used in a non-line-of-sight environment.

Developments in visible light communication (VLC) technology, which is a communication technology for transferring data using visible rays (400-700 nm), there is growing interest in techniques for measuring the position of a user (i.e. a mobile terminal) by utilizing visible light communication.

However, with the existing technology for providing position information using visible light communication, there may be large areas of overlap between the light emitted from different lighting devices, resulting in interference between the light beams. If the area of light emission were to be reduced in order to prevent this problem of interference, however, the intensity of the visible light received at the mobile terminal may be weakened, and shadow areas may occur, making it difficult to obtain a precise position measurement.

### SUMMARY

To resolve the problem above, an aspect of the invention is to provide a lighting apparatus that makes it possible to precisely measure the position of a mobile terminal by reducing interference between visible-light beams emitted from adjacent positions.

Also, an aspect of the invention is to provide a system and method for providing precise position information of a mobile terminal by reducing interference between visible-light beams emitted from multiple lighting devices, as well as a mobile terminal of which position measurement is possible by using the system and method.

Also, an aspect of the invention is to provide a position measuring system and method that can simplify the control of multiple lighting devices used for measuring the position of a mobile terminal.

To achieve the objectives above, an embodiment of the invention provides a lighting apparatus for measuring the position of a mobile terminal by way of visible light communication. The lighting apparatus comprises one or more boundary lighting devices positioned in a boundary part of the lighting apparatus, which are configured to emit visible light that includes information for identifying a position of the mobile terminal (identification information); one or more inner lighting devices positioned in an inner part of the lighting apparatus, which are configured to emit visible light that includes the identification information; and one or more boundary concentrator units, which are implemented respectively on at least some of the one or more boundary lighting devices, and which are configured to concentrate the visible light emitted from the at least some boundary lighting devices.

Another embodiment of the invention provides a position measuring system using visible light. The position measuring system includes a plurality of lighting devices configured to emit visible light including identification information for measuring a position of a mobile terminal, where the plurality of lighting devices are grouped into a plurality of clusters, each of the plurality of clusters comprising two or more lighting devices positioned in a boundary part (boundary lighting devices) and two or more lighting devices positioned in an inner part excluding the boundary part (inner lighting devices). Within one of the clusters, the two or more boundary lighting devices emit visible light that includes first identification information, which is the same among the two or more boundary lighting devices, and the two or more inner lighting devices emit visible light that includes second identification information, which is different among the two or more boundary lighting devices.

Still another embodiment of the invention provides a mobile terminal capable of position measurement. The mobile terminal includes: a receiver part that is configured to receive visible light, which is emitted from a plurality of lighting devices grouped into a plurality of clusters, and which includes identification information for a position measurement of the mobile terminal; and a position measurement part that is configured to measure a position of the mobile terminal by using the identification information. Here, the identification information includes first identification information, which is included in the visible light emitted from two or more lighting devices positioned in a boundary part of each of the plurality of clusters (boundary lighting devices), and second identification information, which is included in the visible light emitted from two or more lighting devices positioned in an inner part excluding the boundary part of each of the plurality of clusters (inner lighting devices).

According to certain embodiments of the invention, it is possible to measure the position of a mobile terminal with greater precision, as well as to simplify the control of the lighting devices used for the position measurement of the mobile terminal.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 illustrates the composition of a position measurement system using visible light communication according to a first disclosed embodiment of the invention.

FIG. 2A and FIG. 2B illustrate the composition of a lighting apparatus according to a first disclosed embodiment of the invention.

FIG. 3A and FIG. 3B illustrate the operation of concentrator units according to an embodiment of the invention.

FIG. 4 illustrates the composition of a position measurement system using visible light communication according to a second disclosed embodiment of the invention.

FIG. 5 illustrates the concept of clusters in a second disclosed embodiment of the invention.

FIG. 6 is a flowchart illustrating the overall flow of a method of providing position information using visible light communication according to a second disclosed embodiment of the invention.

### DETAILED DESCRIPTION

As the present invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In describing the drawings, like reference numerals are used for like elements.

Certain embodiments of the invention will be described below in more detail with reference to the accompanying drawings.

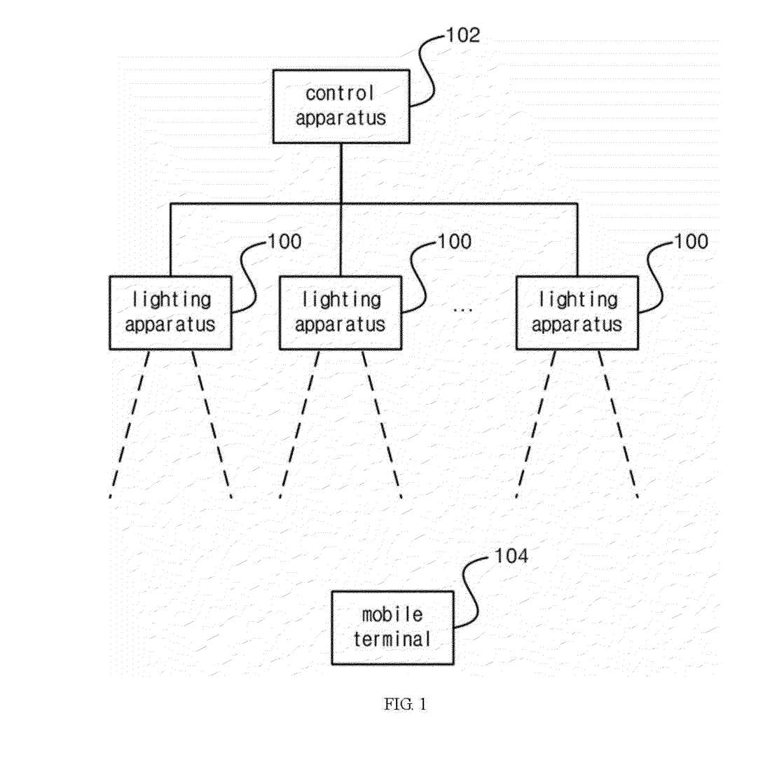

FIG. 1 illustrates the composition of a position measurement system using visible light communication (hereinafter referred to simply as “position measurement system”) according to a first disclosed embodiment of the invention.

Referring to FIG. 1, a position measurement system according to a first disclosed embodiment of the invention can include a multiple number of lighting apparatuses 100 and a control apparatus 102. The function of each component is described below.

The multiple lighting apparatuses 100 may emit visible light. Here, the emitted visible light may include identification information (ID) for measuring the position of a mobile terminal 104. That is, the multiple lighting apparatuses 100 may emit visible light in which identification information is included.

The control apparatus 102 may control the visible light emission of the multiple number of lighting apparatuses 100. That is, the control apparatus 102 may control the multiple lighting apparatuses 100 to incorporate specific identification information into the visible light and thus emit the visible light.

In one example, the control apparatus 102 may confer different identification information for the multiple lighting apparatuses 100, and may provide control such that each of the multiple lighting apparatuses 100 emits visible light that includes different identification information.

The mobile terminal 104 may receive the visible light emitted from a lighting apparatus 100 that is installed near the point at which it is currently located, from among the visible light emitted from the multiple lighting apparatuses 100, and may calculate its position by using the identification information included in the received visible light.

The calculated position of the mobile terminal 104 can be provided to the user by way of a display part implemented on the mobile terminal 104. In one example, the mobile terminal 104 can provide the user with position information by indicating its current position, through the display part, on a mini-map of a location in which multiple lighting apparatuses 100 are installed. Here, the mobile terminal 104 can receive a mini-map and position information on the mini-map corresponding to the respective identification information from a communication apparatus such as a wireless AP installed in the location, and can use these to provide the user with the position information.

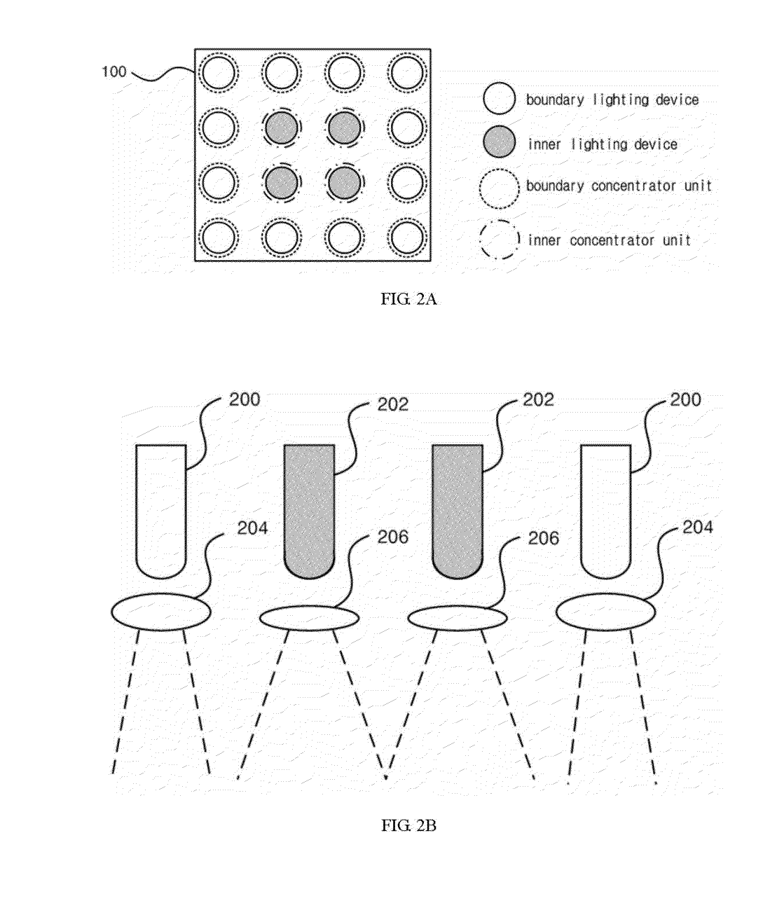

A lighting apparatus 100 according to a first disclosed embodiment of the invention is described below in more detail with reference to FIG. 2A and FIG. 2B.

FIG. 2A and FIG. 2B illustrate the composition of a lighting apparatus 100 according to a first disclosed embodiment of the invention.

More specifically, FIG. 2A is a plan view of the lighting apparatus 100, while FIG. 2B is a side view of the lighting apparatus 100, and as seen in FIG. 2A and FIG. 2B, the lighting apparatus 100 can include a multiple number of lighting devices 200, 202 and two or more concentrator units 204, 206.

The multiple lighting devices 200, 202 may be implemented within one lighting apparatus 100, and as described above, may operate as the actual objects that emit the visible light containing identification information. In one example, each of the multiple lighting devices 200, 202 can be an LED (light emitting diode) device.

More specifically, the multiple lighting devices 200, 202 can be divided into one or more boundary lighting devices 200 that are positioned in a boundary part of the lighting apparatus 100, and one or more inner lighting devices 202 that are positioned in an inner part of the lighting apparatus 100 excluding the boundary part.

Here, the boundary lighting devices 200 and the inner lighting devices 202 can emit visible light with the same identification information incorporated in the visible light. This is so that the lighting apparatus 100 comprising the boundary lighting devices 200 and inner lighting devices 202 may be recognized as one unit position in the position measurement of the mobile terminal.

The two or more concentrator units 204, 206 may be implemented on at least some or all of the multiple lighting devices 200, 202, and may concentrate the visible light emitted from the at least some or all of the lighting devices. Such concentration of visible light may be performed in order to increase the precision of the position measurement for the mobile terminal 104.

Taking a more detailed look, the two or more concentrator units 204, 206 can be divided into one or more boundary concentrator units 204 and one or more inner concentrator units 206.

The boundary concentrator units 204 may be implemented on at least some or all boundary lighting devices 200 from among the one or more boundary lighting devices 200, and may concentrate the visible light emitted from the at least some or all of the boundary lighting devices 200. For the sake of convenience, it will be assumed in the descriptions that follow that the boundary concentrator units 204 are implemented on all of the boundary lighting devices 200.

By thus using boundary concentrator units 204 to concentrate the visible light emitted from the boundary lighting devices 200 (i.e. from the boundary part of the lighting apparatus 100), an embodiment of the invention may reduce the probability of interference between certain visible light rays and other visible light rays emitted from an adjacent lighting apparatus.

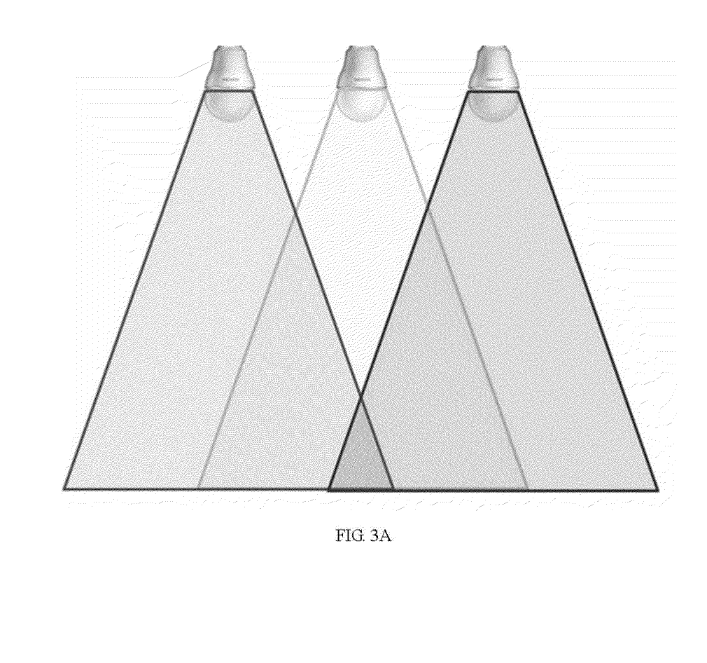

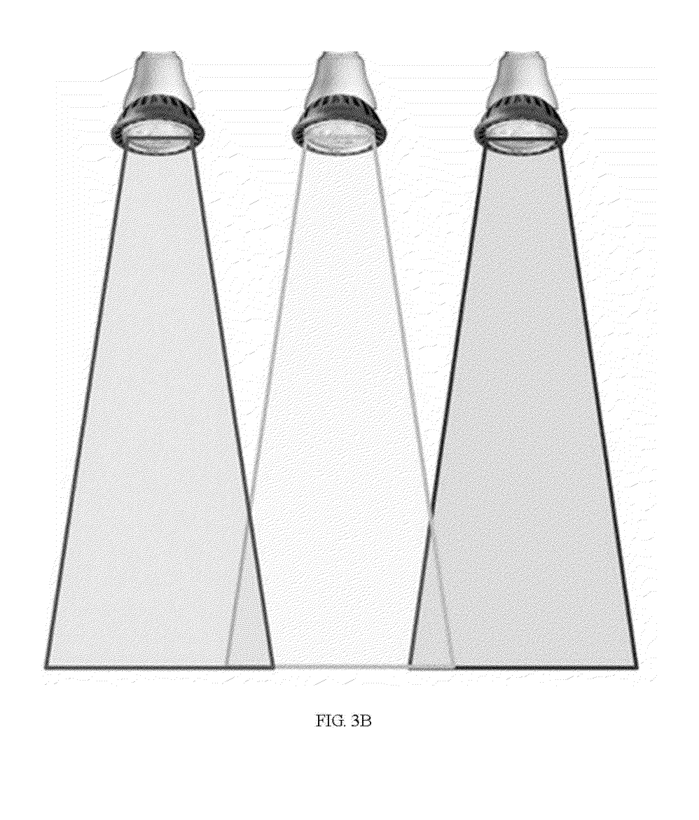

That is, in the case of regular lighting devices that are not equipped with concentrator units 204, such as those illustrated in FIG. 3A, there are wide areas of overlap between the visible light rays emitted from adjacently positioned lighting apparatuses, whereby problems can occur that make precise position measurement impossible. Thus, an embodiment of the invention can have concentrator units 204 attached to the boundary lighting devices 200 of the lighting apparatus 100, as illustrated in FIG. 3B, to reduce the range by which the visible light rays are emitted, thereby minimizing the range of overlap between the visible light rays emitted from adjacent lighting devices and enabling a more precise measuring of the position of the mobile terminal 104.

A lighting apparatus 100 according to a first disclosed embodiment of the invention, while reducing the emission angle of the visible light, may also keep the emission intensity at or above a particular intensity level. As a result, the occurrence of shadow areas, in which the position measurement of the mobile terminal 104 is made impossible due to a weak reception strength of the visible light, can be minimized.

Also, inner concentrator units 206 can be implemented on at least some or all of the one or more inner lighting devices 202, to concentrate the visible light emitted from the at least some or all inner lighting devices 202. For the sake of convenience, it will be assumed in the descriptions that follow that the inner concentrator units 206 are implemented on all of the inner lighting devices 202.

These inner concentrator units 206 may concentrate the visible light emitted from the inner lighting devices 202 to keep the intensity of the emitted visible light at or above a particular intensity level and may thus minimize the occurrence of shadow areas.

According to an embodiment of the invention, the concentration ratio of a boundary concentrator unit 204 can be different from the concentration ratio of an inner concentrator unit 206. Preferably, the concentration ratio of the boundary concentrator unit 204 can be greater than the concentration ratio of the inner concentrator unit 206. Since the visible light emitted from a boundary lighting device 200 is more likely to have interference from the visible light emitted from another adjacent lighting apparatus as described above, the visible light emitted from the boundary lighting device 200 may be concentrated more, so that the amount of interference between visible light rays may be minimized.

In short, a lighting apparatus 100 according to a first disclosed embodiment of the invention can be composed of a multiple number of lighting devices 200, 202, which emit visible light that includes identification information for identifying the position of a mobile terminal, and two or more concentrator units 204, 206, which may be implemented on at least some of the multiple lighting devices 200, 202 to concentrate the visible light. In this case, the two or more concentrator units 204, 206 can be grouped into multiple concentrator unit groups (e.g. a boundary concentrator unit group and an inner concentrator unit group), and the concentration ratios of the concentrator units can differ for each concentrator unit group.

A lighting device included in a lighting apparatus 100 can be an LED unit for lighting, or an LED module that includes multiple LED units for lighting.

A concentrator unit can be implemented individually on each lighting device, as described above, or one concentrator unit can be assigned to two or more lighting devices.

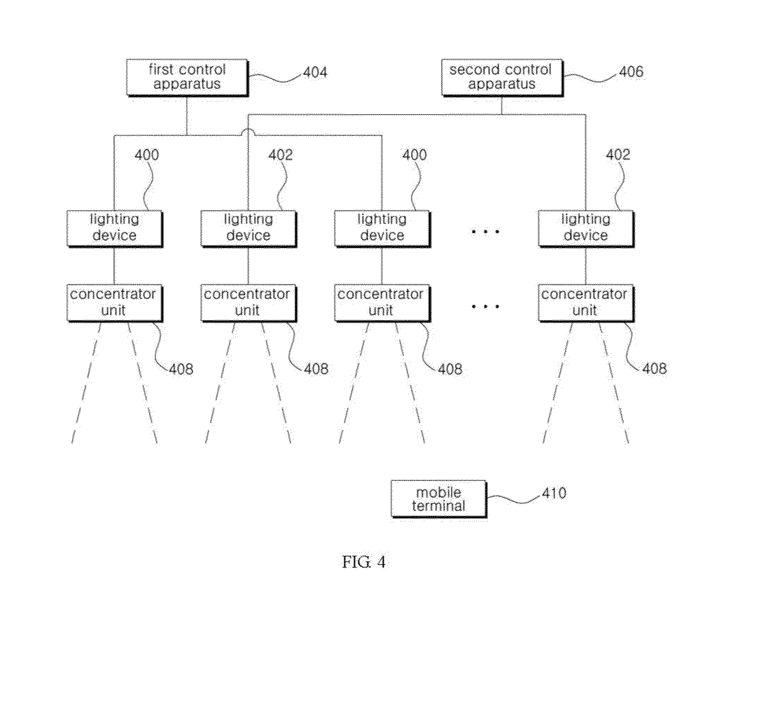

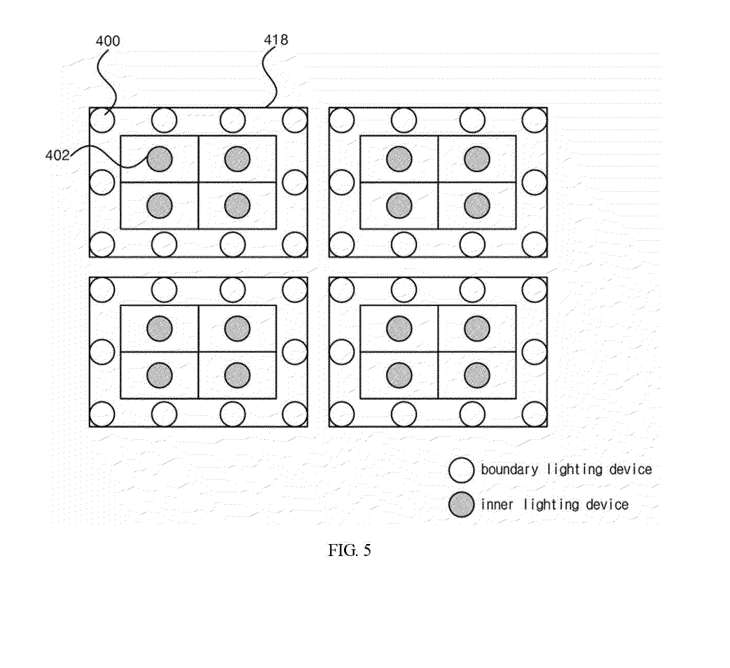

For example, in the example shown in FIG. 2, one concentrator unit can be assigned to the four inner lighting device 202, or two inner lighting devices 202 can be designated to one inner lighting device group and one concentrator unit can be assigned to each of the two inner lighting device groups (i.e. with a total of two concentrator units). The same can apply to the second disclosed embodiment of the invention described later on with reference to FIGS. 4 to 6.

Thus, a lighting apparatus 100 according to a first disclosed embodiment of the invention may use concentrator units to emit and concentrate visible light rays that include identification information, thereby minimizing the occurrence of shadow areas, in which the position measurement of the mobile terminal is made impossible due to a weak reception strength of the visible light, and enabling an increase in the resolution of the position measurement of the mobile terminal.

FIG. 4 illustrates the composition of a position measurement system using visible light communication according to a second disclosed embodiment of the invention.

Referring to FIG. 4, a position measurement system according to a second disclosed embodiment of the invention can include a multiple number of lighting devices 400, 402, a first control apparatus 404, a second control apparatus 406, and a multiple number of concentrator units 408. The function of each component is described below.

The multiple lighting devices 400, 402 may emit visible light. Here, the emitted visible light may include identification information (ID) for measuring the position of a mobile terminal 410, as already described above. That is, the multiple lighting devices 400, 402 may emit visible light in which identification information is included, and the mobile terminal 410 may receive the visible light emitted from a lighting device 400, 402 that is installed near the point at which it is currently located and may provide the user with position information by using the identification information included in the received visible light to calculate its position.

The multiple lighting devices 400, 402 may be grouped into clusters, as illustrated in FIG. 5.

To be more specific, two or more lighting devices 400, 402 may be grouped to form a cluster 418, where each cluster 418 may include two or more lighting devices 400 positioned in a boundary part (hereinafter referred to as “boundary lighting devices”) and two or more lighting devices 402 positioned in an inner part other than the boundary part (hereinafter referred to as “inner lighting devices”). Here, each of the lighting devices 400, 402 can be one or more LED unit for lighting or one or more LED modules that each include multiple LED units for lighting, as already described above. A more detailed description of each lighting device 400, 402 is presented below.

First, a boundary lighting device 400 may emit visible light with first identification information, which is identification information used for identifying the cluster 418 (i.e. position measurement at the level of clusters 418), incorporated into the visible light.

If a user carrying the mobile terminal 410 moves into a location partitioned into units of clusters 418 (e.g. an indoor area), the user must inevitably be positioned inside any one cluster 418 from among the multiple number of clusters 418, and in order for the user to be positioned inside a particular cluster 418, the user must inevitably pass a boundary part of the corresponding cluster 418.

Therefore, according to the second disclosed embodiment of the invention, two or more boundary lighting devices 400 may be positioned along the boundary parts of the clusters 418, and the two or more boundary lighting devices 400 included within one cluster 418 may all emit visible light rays that include the same first identification information (which is the identification information for the corresponding cluster 418), while the first identification information included in the visible light rays emitted by the boundary lighting devices 400 may be different for each cluster 418, so that the mobile terminal 410 is able to measure its position at the cluster level.

In other words, the boundary lighting devices 400 within one cluster 418 may emit visible light that includes the same first identification information, and such first identification information may be different for each cluster 418 (according to the cluster units to which the boundary lighting devices 400 are grouped). That is, the first identification information incorporated into the visible light rays emitted by the two or more boundary lighting devices 400 that are included in a first cluster from among the multiple clusters 418 may be different from the first identification information incorporated into the visible light rays emitted by the two or more boundary lighting devices 400 that are included in a second cluster from among the multiple clusters 418.

Next, the inner lighting devices 402 may emit visible light with second identification information, which is identification information used for the position measurement of the mobile terminal 410 within a cluster 418, incorporated into the visible light.

More specifically, since it is possible to measure the position of the mobile terminal 410 at the level of clusters 418 by using the first identification information emitted from the boundary lighting devices 400 as described above, the two or more inner lighting devices 402 that are positioned inside a cluster 418 according to an embodiment of the invention can be made to emit visible light that includes different second identification information, to enable the measurement of the precise position of the mobile terminal 410 within the corresponding cluster 418.

Here, the two or more sets of second identification information incorporated into the visible light rays emitted by the two or more inner lighting devices 402 that are included in the first cluster from among the multiple clusters 418 can be identical to the two or more sets of second identification information incorporated into the visible light rays emitted by the two or more inner lighting devices that are included in the second cluster of the multiple clusters 418. In other words, the two or more sets of second identification information used for position measurement inside a cluster 418 can be the same for each cluster. This can be regarded as being analogous to the “frequency reuse technique” in cellular communication.

In one example, the two or more boundary lighting devices 400 included in the upper left cluster 418, from among the four clusters 418 illustrated in FIG. 5, can emit visible light that includes first identification information “A”, while the two or more boundary lighting devices 400 included in the upper right cluster 418 can emit visible light that includes first identification information “B”. Also, the four inner lighting devices 402 included in the upper left cluster 418 can emit visible light that includes second identification information “a”, second identification information “b”, second identification information “c”, and second identification information “d”, respectively, and the two or more inner lighting devices 402 included in the upper right cluster 418 can likewise emit visible light that includes second identification information “a”, second identification information “b”, second identification information “c”, and second identification information “d”, respectively.

Also, according to an embodiment of the invention, the second identification information incorporated in the visible light emitted by inner lighting devices 402 that are located in corresponding positions in the two or more cluster 418 can be identical. That is, considering the example shown in FIG. 5, the four inner lighting devices 402 located at the upper left respectively in the four clusters 418 can all include the second identification information “a” in emitting the visible light, the four inner lighting devices 402 located at the upper right can all include the second identification information “b” in emitting the visible light, the four inner lighting devices 402 located at the lower left can all include the second identification information “c” in emitting the visible light, and the four inner lighting devices 402 located at the lower right can all include the second identification information “d” in emitting the visible light.

As the multiple lighting devices 400, 402 emit visible light rays that include first identification information or second identification information as described above, the mobile terminal 410 can calculate its position by combining the first identification information and second identification information included in the received portions of visible light.

Considering this in more detail, a receiver part 412 of the mobile terminal 410 may receive the visible light rays emitted from the multiple lighting devices 400, 402, and a position measurement part 414 of the mobile terminal 410 may measure the position of the mobile terminal 410 by using the identification information included in the received visible light.

In this case, the position measurement part 414 can use the first identification information included in the received visible light rays to select a cluster 418 in which it is determined to be located (i.e. the cluster 418 in which the mobile terminal 410 is located) from among the multiple number of clusters 418, and can use the second identification information included in the received visible light rays to calculate its position within the one selected cluster 418.

The calculated position can be provided to the user through a display part 416 implemented on the mobile terminal 410. In one example, the mobile terminal 410 can provide the user with position information by indicating its current position through the display part 416 on a mini-map of the location where the multiple lighting devices 400, 402 are installed. Here, the mobile terminal 410 can receive the mini-map and position information on the mini-map corresponding to the respective identification information from a communication apparatus such as a wireless AP installed in the location, and can use these to provide the user with the position information.

The first control apparatus 404 may control the visible light emission of the boundary lighting devices 400, from among the multiple lighting devices 400, 402. That is, the first control apparatus 404 may control the two or more boundary lighting devices 400 included in the multiple clusters 418 to emit visible light rays in which first identification information is incorporated.

Since the two or more boundary lighting devices 400 within one cluster 418 may emit the same first identification information and such first identification information may be different for each cluster 418 as described above, the second disclosed embodiment of the invention can use a single first control apparatus 404 to control the visible light emission of the boundary lighting devices 400 present in all clusters 418 collectively. Of course, if the number of output ports of the first control apparatus 404 is fewer than the number of clusters 418 (i.e. the number of sets of first identification information), an identical first control apparatus 404 can be used additionally.

The second control apparatus 406 may control the visible light emission of the inner lighting devices 402, from among the multiple lighting devices 400, 402. That is, the second control apparatus 406 may control the two or more inner lighting devices 402 included in the multiple clusters 418 to emit visible light rays in which second identification information is incorporated.

Since the two or more inner lighting devices 402 within one cluster 418 may emit sets of second identification information that are different from one another (i.e. two or more sets of identification information) and since these two or more sets of second identification information are identical for each cluster 418 as described above, it is possible to control the two or more inner lighting devices 402 included in each cluster 418 through one control apparatus. Therefore, according to the second disclosed embodiment of the invention, a single second control apparatus 404 can be used to control the visible light emission of the inner lighting devices 402 present in all clusters 418 collectively. Of course, if the number of output ports of the second control apparatus 406 is fewer than the number of clusters 418 (i.e. the number of sets of second identification information), an identical second control apparatus 406 can be used additionally.

Thus, a position measurement system according to a second disclosed embodiment of the invention can perform the control of the multiple lighting devices in a dual manner (control of the boundary lighting devices 400 and control of the inner lighting devices 402), thereby simplifying the control of the multiple lighting devices 400, 402 and minimizing the number of control apparatuses used for the control.

Each of the multiple lighting devices can be equipped with a concentrator unit 408. The concentrator unit 408 may serve to concentrate the light that is emitted from the lighting device 400, 402. This concentration of visible light may be performed to increase the precision of the position measurement of the mobile terminal 410.

More specifically, according to an embodiment of the invention, the concentration ratio of a concentrator unit 408 implemented on a boundary lighting device 400 can be greater than the concentration ratio of a concentrator unit 408 implemented on an inner lighting device 402.

As described above, a position measurement system based on an embodiment of the invention may first calculate the position of the mobile terminal 410 at the level of the clusters 418 by using the first identification information included in visible light emitted from the boundary lighting devices 400, and may calculate the position within the cluster 418 by using the second identification information included in visible light emitted from the inner lighting devices 402. An error in the position measurement within a cluster 418 may result in a small error in the position information that is ultimately provided to the user, whereas an error in the position measurement at the level of the clusters 418 may result in a large error in the position information ultimately provided to the user.

Therefore, in an embodiment of the invention, the concentration ratio at the boundary lighting devices 400, which emit visible light that includes first identification information used for position measurement at the level of clusters 418, can be set greater than the concentration ratio at the inner lighting devices 402, which emit visible light that includes second identification information used for position measurement within a cluster 418, so that the precision of the position measurement at the cluster 418 level may be increased.

According to another embodiment of the invention, a lighting apparatus can operate as a cluster 418. In other words, two or more boundary lighting device 200 and two or more inner lighting device 402 can form one lighting apparatus, and the multiple clusters 418 can correspond respectively to multiple lighting apparatuses. In this case, the lighting apparatus can be a lighting apparatus 100 described above with reference to FIG. 1 and FIG. 2.

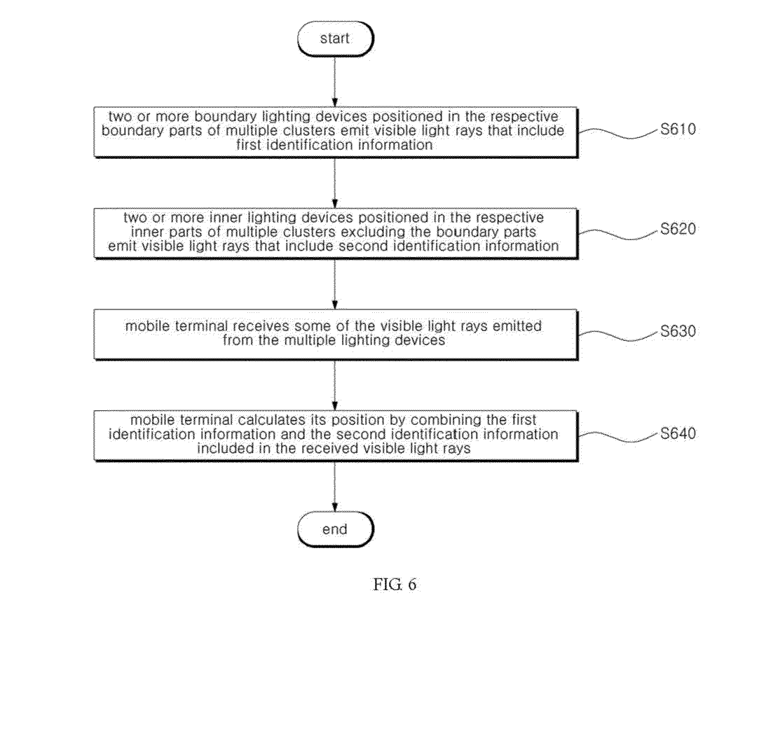

FIG. 6 is a flowchart illustrating the overall flow of a method of providing position information using visible light communication according to a second disclosed embodiment of the invention. The procedure performed for each operation is described below.

First, in operation S610, from among a multiple number of lighting devices grouped into multiple clusters, two or more boundary lighting devices positioned in their respective boundary parts of multiple clusters may emit visible light rays in which first identification information is incorporated.

Here, the first identification information incorporated in the visible light rays emitted by the two or more boundary lighting devices that are included in a first cluster among the multiple clusters may be different from the first identification information incorporated in the visible light rays emitted by the two or more boundary lighting devices included in a second cluster among the multiple clusters. As described above, the first identification information may be identification information used for position measurement at the cluster level.

Next, in operation S620, from among the multiple lighting devices, two or more inner lighting devices positioned in the respective inner parts of the multiple clusters excluding the boundary parts may emit visible light rays in which second identification information is incorporated. Here, the two or more sets of second identification information incorporated into the visible light rays emitted by the two or more inner lighting device included in a first cluster and the two or more sets of second identification information incorporated into the visible light rays emitted by the two or more inner lighting device included in a second cluster may be identical. As described above, the second identification information may be identification information used for position measurement within a cluster.

Although FIG. 6 illustrates the operation in which the boundary lighting devices emit visible light (operation S610) as preceding the operation in which the inner lighting devices emit visible light (operation S620), it will be apparent to those skilled in the art that operation S620 can precede operation S610 and that operation S610 and operation S620 can also be performed simultaneously.

Continuing with the description, in operation S630, the mobile terminal may receive some visible light rays from among the visible light rays emitted by the multiple lighting devices. That is, in operation S630, the mobile terminal may receive the visible light rays emitted from the lighting devices located in its surroundings.

Finally, in operation S640, the mobile terminal may combine the first identification information and the second identification information included in the received visible light rays to calculate its position.

In one example, the mobile terminal in operation S640 can calculate the position at the cluster level by using the first identification information, and then calculate the position within the calculated cluster by using the second identification information.

While the present invention has been described above using particular examples, including specific elements, by way of limited embodiments and drawings, it is to be appreciated that these are provided merely to aid the overall understanding of the present invention, the present invention is not to be limited to the embodiments above, and various modifications and alterations can be made from the disclosures above by a person having ordinary skill in the technical field to which the present invention pertains. Therefore, the spirit of the present invention must not be limited to the embodiments described herein, and the scope of the present invention must be regarded as encompassing not only the claims set forth below, but also their equivalents and variations.

What is claimed is:

1. A lighting apparatus for measuring a position of a mobile terminal by way of visible light communication, the lighting apparatus comprising:
one or more boundary lighting devices positioned in a boundary part of the lighting apparatus, the boundary lighting devices configured to emit visible light including information for identifying a position of the mobile terminal (identification information);
one or more inner lighting devices positioned in an inner part of the lighting apparatus, the inner lighting devices configured to emit visible light including the identification information; and
one or more boundary concentrator units implemented respectively on at least some of the one or more boundary lighting devices, the boundary concentrator units configured to concentrate visible light emitted from the at least some boundary lighting devices.

2. The lighting apparatus for measuring the position of a mobile terminal according to claim 1, further comprising:
one or more inner concentrator units implemented respectively on at least some of the one or more inner lighting devices, the inner concentrator units configured to concentrate visible light emitted from the at least some inner lighting devices.

3. The lighting apparatus for measuring the position of a mobile terminal according to claim 2, wherein a concentration ratio of the one or more boundary concentrator units is different from a concentration ratio of the one or more inner concentrator units.

4. The lighting apparatus for measuring the position of a mobile terminal according to claim 3, wherein the concentration ratio of the one or more boundary concentrator units is greater than the concentration ratio of the one or more inner concentrator units.

5. The lighting apparatus for measuring the position of a mobile terminal according to claim 1, wherein the identification information included in the visible light emitted from the boundary lighting devices and the identification information included in the visible light emitted from the inner lighting devices are identical.

6. A position measuring system using visible light, the position measuring system comprising a plurality of lighting devices configured to emit visible light including identification information for measuring a position of a mobile terminal,
wherein the plurality of lighting devices are grouped into a plurality of clusters, each of the plurality of clusters comprising two or more lighting devices positioned in a boundary part (boundary lighting devices) and two or more lighting devices positioned in an inner part excluding the boundary part (inner lighting devices),
and within one of the clusters, the two or more boundary lighting devices emit visible light including first identification information, the first identification information being identical among the two or more boundary lighting devices, and the two or more inner lighting devices emit visible light including second identification information, the second identification information being different among the two or more boundary lighting devices.

7. The position measuring system using visible light according to claim 6, wherein the first identification information is identification information for identifying the cluster, and the second identification information is identification information for identifying a position within the cluster.

8. The position measuring system using visible light according to claim 7, wherein the mobile terminal receives the visible light emitted from the plurality of lighting devices and performs a position measurement by using the first identification information and the second identification information included in the received visible light, and wherein the first identification information is used to select one cluster in which the mobile terminal is determined to be located, from among the plurality of clusters, and the second identification information is used to calculate a position of the mobile terminal within the one selected cluster.

9. The position measuring system using visible light according to claim 6, wherein the first identification information included in the visible light emitted by the two or more boundary lighting devices included in a first cluster of the plurality of clusters is different from the first identification information included in the visible light emitted by the two or more boundary lighting devices included in a second cluster of the plurality of clusters.

10. The position measuring system using visible light according to claim 9, wherein the two or more second identification information included in the visible light emitted by the two or more inner lighting devices included in the first cluster are identical to the two or more second identification information included in the visible light emitted by the two or more inner lighting devices included in the second cluster.

11. The position measuring system using visible light according to claim 10, wherein the second identification information included in the visible light emitted by inner lighting devices located in corresponding positions in each of the two or more clusters is identical to one another.

12. The position measuring system using visible light according to claim 10, further comprising:
a first control apparatus configured to control the two or more boundary lighting devices included in the plurality of clusters to emit visible light that includes the first identification information; and
a second control apparatus configured to control the two or more inner lighting devices included in the plurality of clusters to emit visible light that includes the second identification information.

13. The position measuring system using visible light according to claim 6, further comprising:
a plurality of concentrator units implemented respectively on the plurality of lighting devices, the concentrator units configured to concentrate the emitted visible light.

14. The position measuring system using visible light according to claim 13, wherein a concentration ratio of concentrator units implemented on the boundary lighting devices is greater than a concentration ratio of concentrator units implemented on inner lighting devices.

15. A mobile terminal capable of position measurement, the mobile terminal comprising:
a receiver part configured to receive visible light emitted from a plurality of lighting devices grouped into a plurality of clusters, the visible light including identification information for a position measurement of the mobile terminal; and
a position measurement part configured to measure a position of the mobile terminal by using the identification information,
wherein the identification information includes first identification information included in visible light emitted from two or more lighting devices positioned in a boundary part of each of the plurality of clusters (boundary lighting devices) and second identification information included in visible light emitted from two or more lighting devices positioned in an inner part excluding the boundary part of each of the plurality of clusters (inner lighting devices).

16. The mobile terminal according to claim 15, wherein the position measurement part uses the first identification information to select one cluster in which the mobile terminal is determined to be located, from among the plurality of clusters, and uses the second identification information to calculate a position of the mobile terminal within the one selected cluster.

17. The mobile terminal according to claim 15, wherein the first identification information included in the visible light emitted by the two or more boundary lighting devices included in a first cluster of the plurality of clusters is different from the first identification information included in the visible light emitted by the two or more boundary lighting devices included in a second cluster of the plurality of clusters.

18. The mobile terminal according to claim 17, wherein the two or more second identification information included in the visible light emitted by the two or more inner lighting devices included in the first cluster are identical to the two or more second identification information included in the visible light emitted by the two or more inner lighting devices included in the second cluster.
